(19) United States
(12) Patent Application Publication
(10) Pub. No.: US 2016/0196557 A1
(43) Pub. Date: Jul. 7, 2016

(54) CLOUD-BASED PAYMENT PROCESSING

(71) Applicants: Richard Travis Davis, Santa Barbara, CA (US); Michael David Sheffey, Santa Barbara, CA (US)

(72) Inventors: Richard Travis Davis, Santa Barbara, CA (US); Michael David Sheffey, Santa Barbara, CA (US)

(73) Assignee: Axia Payments, Inc., Santa Barbara, CA (US)

(21) Appl. No.: 14/988,313

(22) Filed: Jan. 5, 2016

Related U.S. Application Data
(60) Provisional application No. 62/099,972, filed on Jan. 5, 2015.

(51) Int. Cl. G06Q 20/40; G06Q 20/14

(52) U.S. Cl. CPC G06Q 20/405; G06Q 20/14

(57) ABSTRACT

Method and systems are described that enable transactions to be processed between a client and multiple terminals without the need for physical cables or dedicated proxies. Additionally, long polling may be used between a terminal and a cloud server to ensure that transaction may be processed efficiently. In some embodiments, the transactions may be conducted over the Internet and the client may be integrated with an ISV.

This application is entitled to the benefit and filing date of U.S. Provisional Application No. 62/099,972, which application is incorporated by reference in its entirety herein.

### BACKGROUND OF THE INVENTION

1. Field of the Invention

This present invention relates to apparatus, systems, methods, and related computer program products for handling communications between a plurality of entities and for authenticating devices and communicating with one another via cloud servers. More particularly, the present invention relates to processing transactions using multi-tiered authentication methods via a cloud-based architecture.

2. Background

Transactions over networks are commonplace. In one example, payment networks typically include a merchant who is provided with a payment card from a customer to pay for products or services. Generally, the payment card is read by a processing device and an authorization request is sent to a payment network. The network routes an authorization request to a bank. The issuer approves or declines the transaction and returns an authorization response to the merchant via the network. If approved, the bank sends authorization to the merchant over the network.

Current payment processes require significant infrastructure, extensive knowledge for integration, do not operate seamlessly with mobile or other handheld devices, and increase the risk of fraudulent transactions as card and identification information are not adequately protected.

In one example, independent software vendors (ISV) process card-based transactions with need of a direct physical connection between a computing device that is running/accessing ISVs software and a terminal for processing the card based transaction. Moreover, in such systems, there is a need to install software application, software drivers, and the like on the computing device and to ensure that such applications and drivers are locally up-to-date. Additionally, in some cases, there is a need of having a network proxy and/or network hardware device that allows for the computing device to communicate with a terminal for the purpose of processing a card-present transactions.

Therefore, a need exists for a transactional architecture that supports processing via cloud computing and reduces the need for a physical connections, localized software applications and drivers, and dedicated network proxies or hardware between the computing device running the ISV application and the terminal processing the payment transaction. Other devices, apparatus, systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The invention may be better understood by referring to the following figures. The components in the figures are not necessarily to scale, emphasis instead being placed upon illustrating the principles of the invention. In the figures, like reference numerals designate corresponding parts throughout the different views.

FIG. 1 illustrates an example of transactional architecture in an embodiment.

FIG. 2 illustrates an example of a transactional process in an embodiment.

### SUMMARY OF THE INVENTION

In one aspect, a method for conducting transactions over a network is described and includes polling a cloud server via a terminal for a transaction to be processed, wherein the polling includes a unique identification associated with the terminal and an availability flag indicating whether the terminal is free or busy; authenticating an Independent Service Provider (ISV) via a cloud server including providing transaction information concerning a transaction to be completed and selecting a terminal to process the transaction; determining by long polling if the terminal is available and saving the transaction information and closing any connection with the ISV; if the terminal is available by the availability flag set to free, sending by the cloud server the transaction information to the terminal and closing any connection between the terminal and the cloud server in response to the polling the cloud server; long polling the cloud server to indicate that the terminal is busy and processing the transaction between the terminal and an authorization system; and contacting the cloud server by the terminal whether the transaction was approved or denied. The cloud server may inform the ISV that the transaction has been approved or denied.

In another aspect, the ISV may informs the client that the transaction has been approved or denied. The client may be integrated with the ISV. The long polling step and the contacting step may be asynchronous or synchronous. The terminal and the client may be located behind a firewall.

In another aspect, multiple clients may be communication with the terminal and the transaction information includes invoice and billing information. The processing the transaction may include receiving credit card information, and conducting the transaction may use HTTPS.

In another aspect, the method and systems may use the Internet and the client and the terminal are authenticated using tokens individually assigned to the client and terminal, respectively.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### DETAILED DESCRIPTION

Each of the additional features and teachings disclosed below can be utilized separately or in conjunction with other features and teachings to provide a device, system, and/or method for illuminating an object, such as a bottle or can. Representative examples of the present invention, which examples utilize many of these additional features and teachings both separately and in combination, will now be described in further detail with reference to the attached drawings. This detailed description is merely intended to teach a person of skill in the art further details for practicing preferred aspects of the present teachings and is not intended to limit the scope of the invention. Therefore, combinations of features and steps disclosed in the following detail description may not be necessary to practice the invention in the broadest sense, and are instead taught merely to particularly describe representative examples of the present teachings

Moreover, the various features of the representative examples and the dependent claims may be combined in ways that are not specifically and explicitly enumerated in order to provide additional useful embodiments of the present teachings. In addition, it is expressly noted that all features disclosed in the description and/or the claims are intended to be disclosed separately and independently from each other for the purpose of original disclosure, as well as for the purpose of restricting the claimed subject matter independent of the compositions of the features in the embodiments and/or the claims. It is also expressly noted that all value ranges or indications of groups of entities disclose every possible intermediate value or intermediate entity for the purpose of original disclosure, as well as for the purpose of restricting the claimed subject matter.

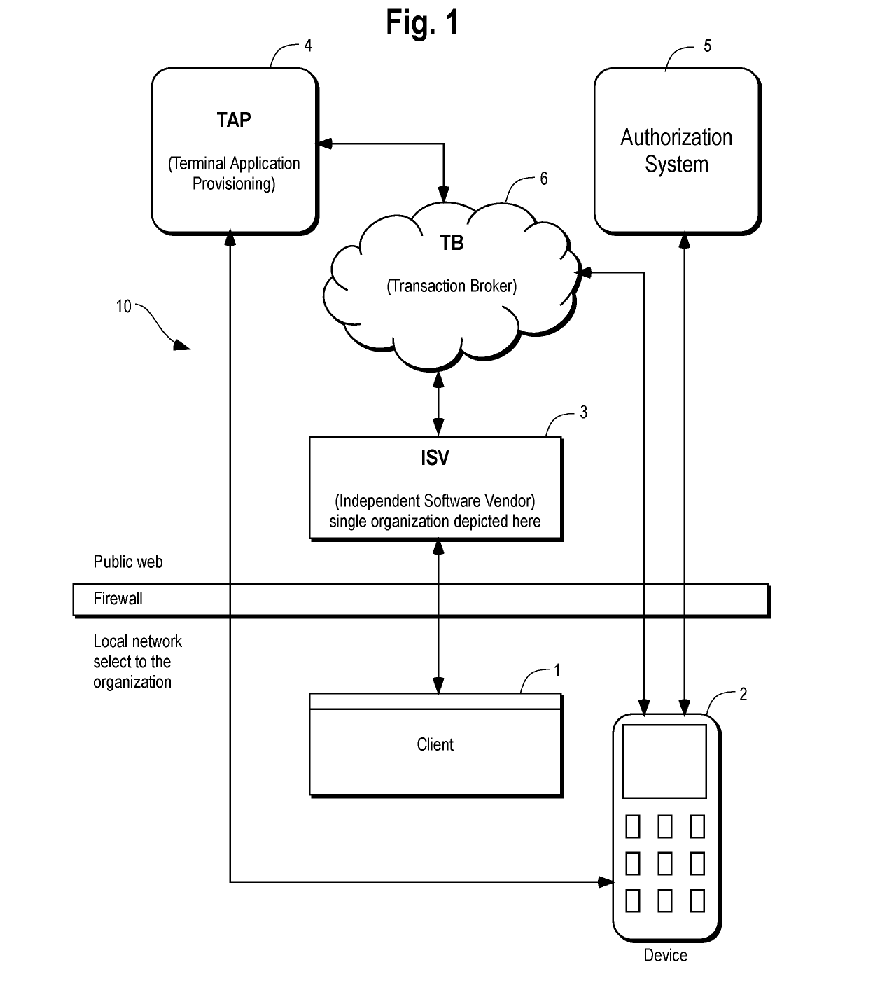

Devices, methods, and systems are described for conducting transactions using a cloud-based architecture. The architecture may include a device or terminal coupled or linked to a client with a browser located behind a firewall. It should be understood that the term “device” or “terminal” are used interchangeably herein and include a mobile device that is capable of accepting a credit card. One example of such a device or terminal is device 2 of FIG. 1. In one embodiment, the device may poll a cloud server, such as TB 6 described below, for any transactions to be processed. The device may use one or more authentication, encryption, or security protocols to communicate with the cloud server. In one example, a client may be used to receive authentication information from a user, information about the bill to be paid, and/or a device to read the user's credit card information. The information may be sent to an ISV, which may be a web server or other type of server. The ISV may be located on either side of a firewall and may be separate or integrated with the client. The ISV pass the information to a cloud server, which then communicates with a terminal to conduct the credit card transaction.

FIG. 1 illustrates an example of a transaction processing architecture 10 in an embodiment. The architecture 10 may include a client 1 and a device or terminal 2. The client 1 may be any application and or browser capable of connecting to a network, such a LAN WAN, MAN, the Internet etc. The client 1 may include a browser provided from such companies as Google, Microsoft, Firefox, Apple, and the like. The browser may be accessed on a computer, laptop, mobile device, or any other general computing device with hardware and software capable of connecting to a network wired or wirelessly. The device 2 may be an apparatus with a CPU, display, and electronic components to communicate over a network. The device 2 and the client 1 may be located behind a firewall. In other embodiments, the client 1 and device 2 may only be configured to initiate a connection. In one embodiment, one or more clients 1 may be coupled or linked to one or more devices 2. In other embodiments, any number of clients 1 may be coupled or linked to any number of devices.

The architecture 10 may also include ISV 3. In one embodiment, ISV 3 may be any conventional web server. One or more ISVs 3 may be used in the architecture 10. The ISV 3 may be in wired or wireless communication with the client 1. The ISV 3 may be in wired or wireless communication with Terminal Application Provisioning System (TAP) 4 and/or a Transaction Broker (TB) 6, which is a cloud server. The TAP 4 may be any commercially available web server and configured with instructions and methods described herein. The TAP 4 and/or TB 6 may be in wired or wireless communication with the device 2. One or more devices 2 may communicate with one or more cloud servers in some embodiments.

The device 2 may be in wired or wireless communication with an authorization system 5. One or more gateways 5 may communicate with one or more devices 1.

The present invention provides several advantages. First, ISVs may be configured to process card-present transactions through a device, such as device 2, without a need of a direct physical connection between terminal 2 and client 1, such as a personal computer (PC), handheld device, tablet, or the like. Second, the TAP 4 may be used to provision terminal 2 and provide changes to the ISV remotely. Third, there is no need for a dedicated network proxy and or network hardware device that allows for the client 1 and the device 2 to communicate with each other for the purpose of processing a card-present transaction. This means that one client 1 may communicate with more than one terminal 2 or one terminal 2 may communicate with more than one client 1.

In some embodiments, the methods and apparatus of the invention provide a scalable solution including a client 1 with a Representational State Transfer (REST) Application Program Interface (API) with which ISVs are indirectly able to interact with any number of Point of Sale (POS) terminals, such as terminals 2, associated with a particular account. In some embodiments, interactions include managing transactions that are performed by the terminals themselves, such as device 2, using point to point encryption on sensitive data between them and a payment gateway, such as authorization system 5. In this latter configuration, leakage of sensitive information may be controlled between any point-to-point communications in the system of FIG. 1. In one embodiment, any traffic communicated in the system of FIG. 1 may use HTTPS.

In one embodiment, an ISV, such as ISV 3, may identify a terminal or device, such as device 2, for payment. Once a terminal is selected, a simple POST call may be performed and—if the terminal is online—the transaction may be accepted and sent to the terminal for processing immediately. In one embodiment, the transaction may include non-critical data such as the amount and billing details, but not credit card information.

Once the non-critical data is received by the terminal, critical information such as the credit card information is received by terminal 2 and subsequently sent to the authorization system 5 from the terminal 2. After confirmation or denial of payment by authorization system 5, the terminal 2 may contact the TB 6 by another API call that the transaction was completed. The transaction results back may then be sent to the ISV either directly by calling a special URL that was specified by the ISV when creating the transaction or by letting the ISV poll for the transaction result.

In some embodiments, one or more terminals 2 may also be connected to the TB 6 by long polling to indicate which terminal 2 may be online and available to conduct transactions or other tasks. In some embodiments, the terminal 2 may include a flag indicating that the terminal is busy, when flag is set to false. In other embodiments, the flag may be set to true to indicate that the terminal is free.

The ISV 3 may receive the information and communicate the information to a cloud server, such as TB 6. The cloud server 6 may verify the availability of the device, such as device 2, using long polling. Long polling may include a timer on the client side, such as client 1 that may send requests periodically in order to ask ISV 3, if there is a new message or transaction to be processed. The long polling may be synchronous or asynchronous with other communications between components in architecture 10. Assuming there is no immediate message, the ISV 3 may delay the reply with a specified amount of time or period awaiting for a notification for that particular terminal 2. If a notification occurs in this period, the ISV 3 replies immediately. When the period expires, the ISV 3 may reply with empty meaning that there are no new transactions, and the terminal 2 may send a new request to begin a new long polling session. The long poll period can be a few seconds to many minutes. In one embodiment, there may be no traffic over this waiting period if there are no updates from the ISV.

In one example, a payment request may be sent from the cloud server, such as TB 8, to the device, such as device or terminal 2. A message requesting the credit card information may be displayed on the device and a card may be swiped. In other embodiments, payment may be made using RFID, barcode, mobile wallet, NFC, iBeacon, or other similar techniques that allow for processing a transaction. An approval or denial request for the transaction may be processed at the authorization system 5. The authorization system 5 may inform the device of the outcome of the authorization. The cloud server will be notified of the outcome by the device. The cloud server may then provide the outcome of the authorization system processing to the ISV 3, which then may inform the client 1.

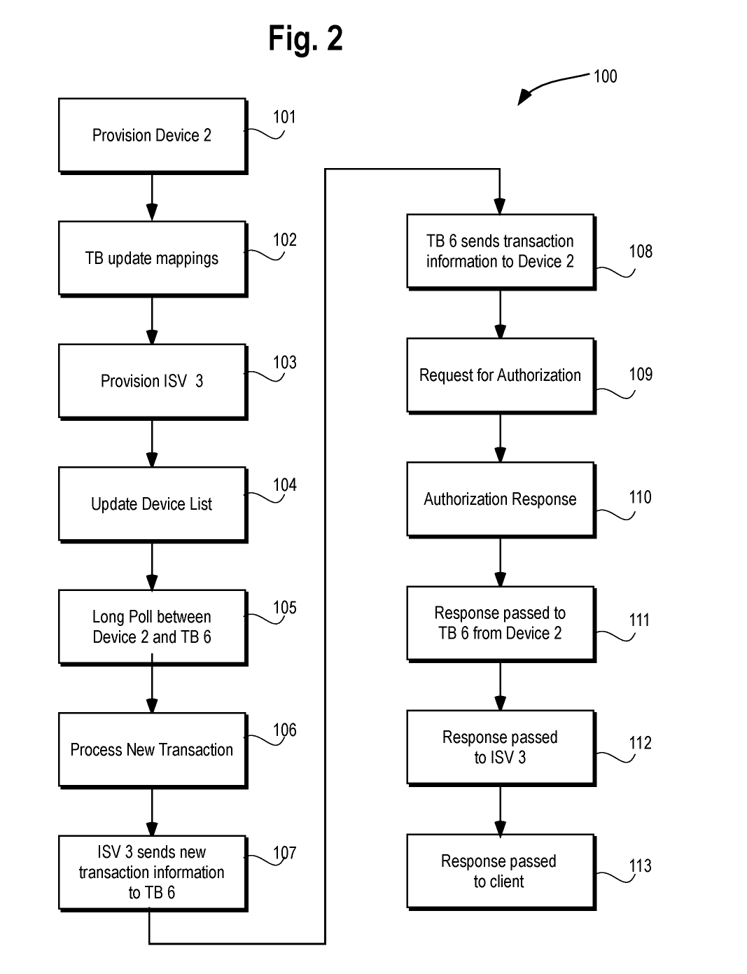

In some embodiments, the terminal 2 may be any device that is capable of processing transactions and the input of transaction information may be provided by a magnetic stripe, a wireless connection, a hard-wired connection, near field communication, GRPS, chip and pin, EMV, blue tooth, iBeacon or any other type of communication method. It is to be understood that the transaction information may include any type of information that is supported by architecture 10. An example of a transaction 100 may be as follows and shown in FIG. 2. It is to be understood that any of the steps in any combination of FIG. 2 may be performed in any order as necessary depending on the configuration and requirements of a specific implementation.

In step 101, the device 2 may be provisioned or authenticated by TAP 4. In one embodiment, the terminal 2 may receive a token from TAP 4 and if the token is accepted upon input into the terminal 2, the TAP may register the terminal 2 using the terminal's serial number or other unique ID number. In some embodiments, the TAP 4 may update the terminal with the most recent software or other information concerning the architecture 10.

Once the provisioning occurs, a request from TAP 4 to TB 6 may optionally occur in step 102. After each modification on a device 2 (add/delete/update) or TAP 4, the TAP 4 may make a request to the TB 6 to update the mappings (each organization has many locations and each location has many devices).

In step 103, In one embodiment, the ISV 3 and/or client 1 may be provisioned through TAP 4 by using a token process in which the ISV is provided one or more tokens.

In step 104, a request from ISV 3 to TB 6 may occur to request an updated list of devices 2 associated with the organization. In step 105, a request from device 2 to TB 6 may occur and the terminal will long poll the TB 6 to determine if there any pending transactions. In one embodiment, the terminal 2 may have an availability flag set to true to indicate that the terminal is capable of receiving and processing transactions.

In step 106, a request from client 1 to ISV 3 may occur to start processing a new transaction. In other embodiments, the ISV 3 and client 1 may be integrated and thus steps 106 and 107 may be performed in a single step. In step 107, a request from ISV 3 to TB 6 may occur to communicate to TB 6 to send information about a new transaction, including billing information and the terminal 2 to be used.

In step 108, a response from TB 6 to the device 2 may occur to transfer the transaction information from the ISV 3 as a reply for the request sent from the device 2 sent in in step 105. In one embodiment, the link between the ISV 3 and TB 6 in steps 106 and/or 107 may be closed.

In step 109, a request from device 2 to authorization system 5 may occur after a credit card number is received by the terminal 2 to verify or decline the transaction. In one embodiment, the terminal 2 may have an availability flag set to false to indicate that the terminal is not free and thus cannot receive and process transactions.

In step 110, a response from authorization system 5 to device 2 may occur. In one embodiment, the result of the transaction may be sent via POST from the authorization system 5 to the device 2.

In step 111, a request from device 2 to TB 6 may occur to pass the response from the authorization system to the TB. In step 112, a request from ISV 3 may be issued to TB 6. The ISV 3 may issue a request to TB to check the transaction status (e.g., a card was swiped response and accepted or declined). In step 112, alternatively, a special URL that was specified by the ISV 3 when creating the transaction or by letting the ISV 3 poll for the transaction result a callback request may be sent from the TB 6 to ISV 3.

In step 113, a request for Response from ISV Server to client or browser may occur. The ISV may returns an HTTP response to the browser to be displayed.

The described devices, systems and methods have credit card and other information passed only between the device and authorization system in some embodiments. In one embodiment, all information is carried over HTTPS. Additional tokens may be used to verify any of the components of the architecture 10 including the device 2, client 1, ISV 3, cloud server 6, and authorization system 5. In some embodiment, the cloud server 4 may use any type of storage including persistent storage. In other embodiments, the cloud server 4 may log events.

The present invention or any part(s) or function(s) thereof, may be implemented using hardware, software, or a combination thereof, and may be implemented in one or more computer systems or other processing systems. A computer system for performing the operations of the present invention and capable of carrying out the functionality described herein can include one or more processors connected to a communications infrastructure (e.g., a communications bus, a cross-over bar, or a network). Various software embodiments are described in terms of such an exemplary computer system. After reading this description, it will become apparent to a person skilled in the relevant art(s) how to implement the invention using other computer systems and/or architectures.

The foregoing description of the preferred embodiments of the present invention has been presented for purposes of illustration and description. It is not intended to be exhaustive or to limit the invention to the precise form or to exemplary embodiments disclosed. Obviously, many modifications and variations will be apparent to practitioners skilled in this art. Similarly, any process steps described might be interchangeable with other steps in order to achieve the same result. The embodiment was chosen and described in order to best explain the principles of the invention and its best mode practical application, thereby to enable others skilled in the art to understand the invention for various embodiments and with various modifications as are suited to the particular use or implementation contemplated. It is intended that the scope of the invention be defined by the claims appended hereto and their equivalents. Reference to an element in the singular is not intended to mean “one and only one” unless explicitly so stated, but rather means “one or more.” Moreover, no element, component, nor method step in the present disclosure is intended to be dedicated to the public regardless of whether the element, component, or method step is explicitly recited in the following claims. No claim element herein is to be construed under the provisions of 35 U.S.C. Sec. 112, sixth paragraph, unless the element is expressly recited using the phrase “means for . . . .”

Furthermore, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way. It is also to be understood that the steps and processes recited in the claims need not be performed in the order presented.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

1. A method for conducting transactions over a network, comprising:
polling a cloud server via a terminal for a transaction to be processed, wherein the polling includes a unique identification associated with the terminal and an availability flag indicating whether the terminal is free or busy;
authenticating an Independent Service Provider (ISV) via a cloud server including providing transaction information concerning a transaction to be completed and selecting a terminal to process the transaction;
determining by long polling if the terminal is available and saving the transaction information and closing any connection with the ISV;
if the terminal is available by the availability flag set to free, sending by the cloud server the transaction information to the terminal and closing any connection between the terminal and the cloud server in response to the polling the cloud server;
long polling the cloud server to indicate that the terminal is busy and processing the transaction between the terminal and an authorization system;
contacting the cloud server by the terminal whether the transaction was approved or denied.

2. The method of claim 1, wherein the cloud server informs the ISV that the transaction has been approved or denied.

3. The method of claim 2, wherein the ISV informs the client that the transaction has been approved or denied.

4. The method of claim 2, wherein the client is integrated with the ISV.

5. The method of claim 1, wherein the long polling step and the contacting step are asynchronous.

6. The method of claim 1, wherein the long polling step and the contacting step are synchronous.

7. The method of claim 1, wherein the terminal and the client are located behind a firewall.

8. The method of claim 1, wherein multiple clients are in communication with the terminal.

9. The method of claim 1, wherein the transaction information includes invoice and billing information.

10. The method of claim 1, wherein processing the transaction includes receiving credit card information.

11. The method of claim 1 further comprising conducting the transactions using HTTPS.

12. The method of claim 1, wherein the network in the Internet.

13. The method of claim 1, wherein the client and the terminal are authenticated using tokens individually assigned to the client and terminal, respectively.

14. A computer program product, stored on a non-transitory computer readable medium, comprising instructions that, when executed on one or more computers, cause the one or more computers to perform operations conduct transactions over a network, comprising:
polling a cloud server via a terminal for a transaction to be processed, wherein the polling includes a unique identification associated with the terminal and an availability flag indicating whether the terminal is free or busy;
authenticating an Independent Service Provider (ISV) via a cloud server including providing transaction information concerning a transaction to be completed and selecting a terminal to process the transaction;
determining by long polling if the terminal is available and saving the transaction information and closing any connection with the ISV;
if the terminal is available by the availability flag set to free, sending by the cloud server the transaction information to the terminal and closing any connection between the terminal and the cloud server in response to the polling the cloud server;
long polling the cloud server to indicate that the terminal is busy and processing the transaction between the terminal and an authorization system; and
contacting the cloud server by the terminal whether the transaction was approved or denied.

15. The method of claim 14, wherein the cloud server informs the ISV that the transaction has been approved or denied.

16. The method of claim 15, wherein the ISV informs the client that the transaction has been approved or denied.

17. The method of claim 15, wherein the long polling step and the contacting step are asynchronous.

18. The method of claim 15, wherein the long polling step and the contacting step are synchronous.

19. The method of claim 15, wherein the terminal and the client are located behind a firewall.

20. The method of claim 15, wherein multiple clients are in communication with the terminal.
